(19) United States
(12) Patent Application Publication
(10) Pub. No.: US 2011/0199307 A1
(43) Pub. Date: Aug. 18, 2011

(54) Keyboard and touchpad arrangement for electronic handheld devices

(76) Inventors: Huy Hai Dinh, Pittsburgh, PA (US); Phi Nguyet Bui, Pittsburgh, PA (US); AnhQuan Hoang Dinh, Pittsburgh, PA (US); DucAnh Hoang Dinh, Pittsburgh, PA (US)

(21) Appl. No.: 12/704,551

(22) Filed: Feb. 12, 2010

(51) Int. Cl. G06F 3/02; G06F 3/041

(52) U.S. Cl. 345/168

(57) ABSTRACT

A handheld electronic device arrangement for thumb-typing is invented. A regular computer keyboard is split into two groups of keys. The right group of keys is located on the right side of the device for the right thumb typing and the left group of key is placed on the left side of the device for the left thumb typing. The left and right groups of keys are arranged longitudinally. The touchpad is located on the back and the right side of the device for the right index finger operating. Three mouse buttons are located on the back and the left side of the device for the left index, middle, and ring fingers operating.

### REFERENCES CITED

U.S. Pat. No. 7,561,685 Jul. 14, 2009 Griffin et al.

### FIELD OF THE INVENTION

The invention relates to a display, a keyboard, three mouse buttons, and touchpad arrangement for a handheld electronic device.

### BACKGROUND

Present day, computers and mobile telephones are convergent in smart hand held electronic devices. Because the small size and the way users hold these devices, the present computer keyboards, mice and touchpad are not suitable. More and more users replace their computer or game console screens with big flat screen TVs. Present computer keyboards and mice are too big, heavy, and inconvenient.

### SUMMARY OF THE INVENTION

The present invention overcomes above drawbacks. The invention divides three letter key rows of conventional computer keyboard into two groups of keys. To enable users to use their thumbs to type easily while they hold handheld electronic device, the invention arranges these groups of keys into the left side and right side of the device. In present keyboards, rows of keys are arranged across for ten finger typing. The invention arranges rows of keys longitudinally for thumb typing. One Alt key are added to each group of keys in order to add additional function to other keys in the keyboard. Three mouse buttons are placed on the back of the device and under the left group of keys so that users can use their left index, middle, and ring fingers to click left, middle, and right mouse buttons respectively. The touchpad is placed on the back of the device and under the right group of keys so that users can use their right index finger to operate the touchpad. This arrangement enable users use device without a mouse easily.

### BRIEF DESCRIPTION OF THE DRAWINGS

Having thus described the invention in general terms, references will now be made to the accompanying drawings, which are not necessarily drawn to scale, wherein keys representing letters in the keyboard are laid out according to the QWERTY layout, and wherein:

FIG. 1 is the front view of the arrangement of the device.

FIG. 2 is the back view of the arrangement of the device.

FIG. 3 shows functions of each key of the keyboard while one of the Shift keys is depressed.

FIG. 4 shows functions of each key of the keyboard while one of the Alt keys is depressed.

FIG. 5 shows functions of each key of the keyboard.

### DETAILED DESCRIPTION OF THE INVENTION

The present invention now will be described more fully hereinafter with reference to the accompanying drawings, in which one example of the embodiments of the invention are shown. Indeed, the invention may be embodied in many different forms and should not be construed as limited to the embodiment set forth herein; rather, the embodiment is provided by way of example so that this disclosure will satisfy applicable legal requirements. The invention only shows the arrangement of keyboard, touchpad and mouse buttons. The hand held electronic device contains other components to make it work properly. Those skilled in the art understand of these components. Therefore, the invention will not describe how these components work.

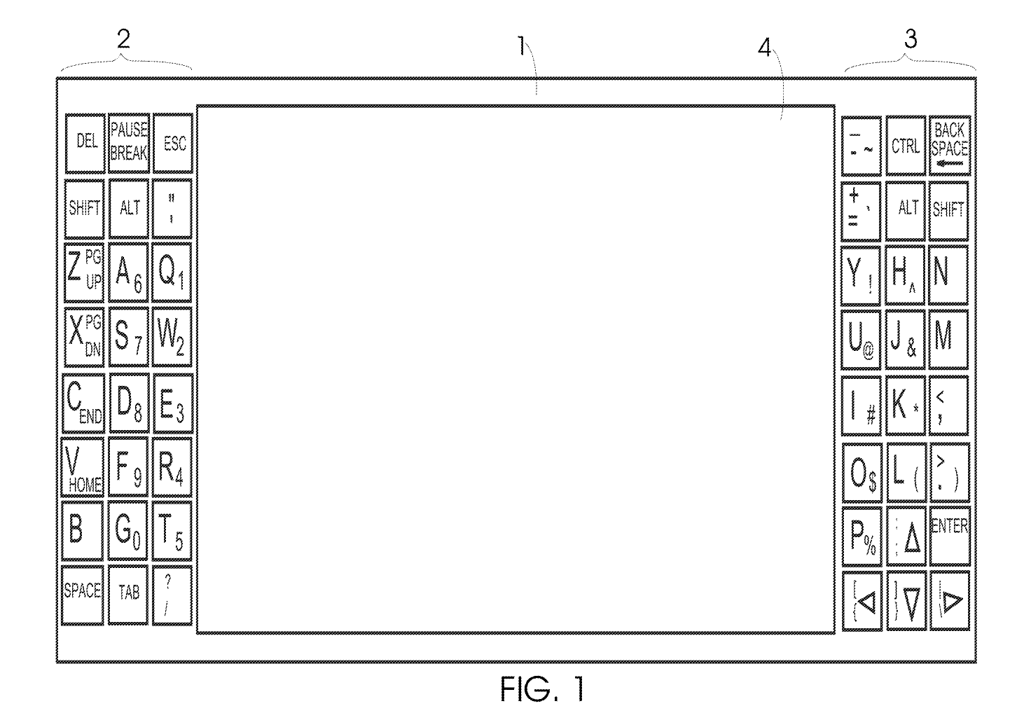

FIG. 1 illustrates front view of a handheld electronic device (1). The keyboard of the handheld electronic device (1) is split into two group of keys and laid out in the QWERTY fashion. The left group of keys (2) is located on the left side of the display (4). The right group of keys (3) is located on the right side of the display (4). Each group of keys has three rows of keys. All rows of keys are paralleled to the longitudinal midline of the handheld electronic device (1). While users hold the handheld electronic device (1) by its left and right sides, their right thumbs can conveniently depress each key in the right group of keys (3) and their left thumbs can conveniently depress each key in the left group of keys (2). The popular QWERTY keyboard layout helps users to remember function of each keys.

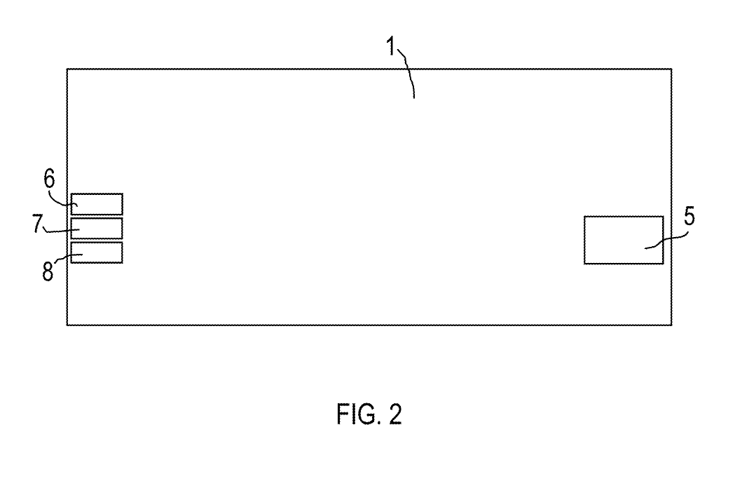

FIG. 2 illustrates back view of the handheld electronic device (1). The touchpad (5) is located on the right side of the device (1) so that users can use their right index finger to operate the touchpad (5) easily while holding the right side of the device (1). The left mouse button (8), the middle mouse button (7), and the right mouse button (6) are located on the left side of the device (1) so that users can easily use their left index, middle, and ring fingers respectively to click them while holding the left side of the device (1).

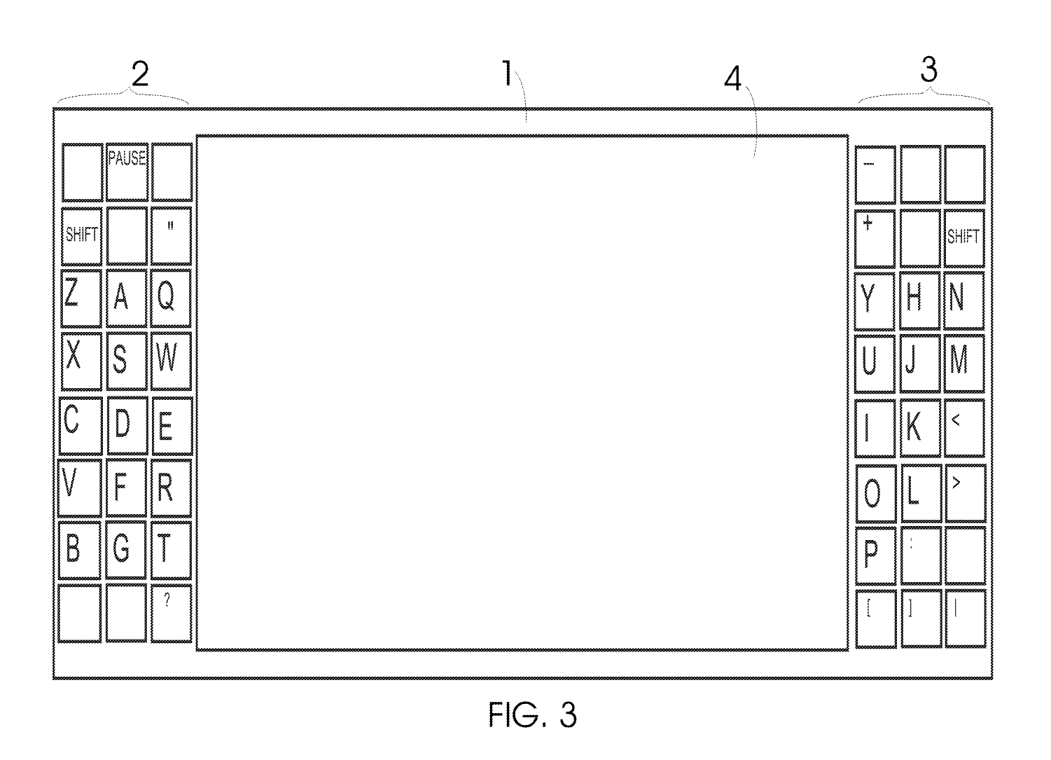

FIG. 3 shows the function of each key of left group of keys (2) and right group of keys (3) while one of the Shift keys is depressed. Blank key indicates that additional function can be added to that key.

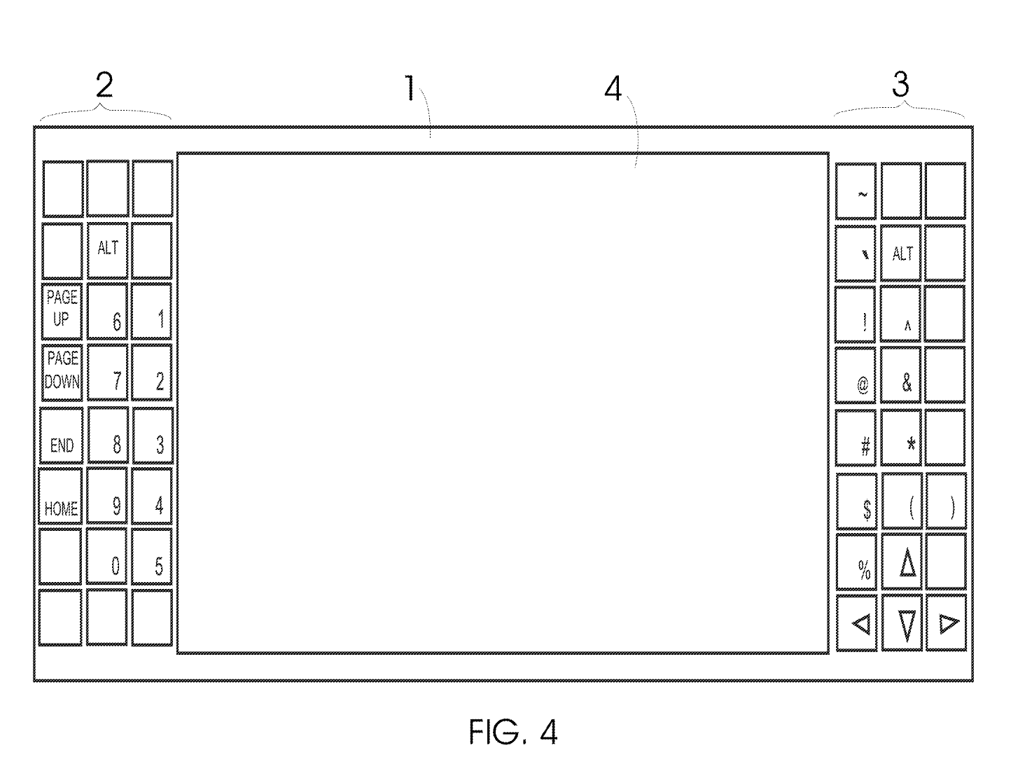

FIG. 4 shows the function of each key of left group of keys (2) and right group of keys (3) while one of the Alt keys is depressed. Blank key indicates that additional function can be added to that key.

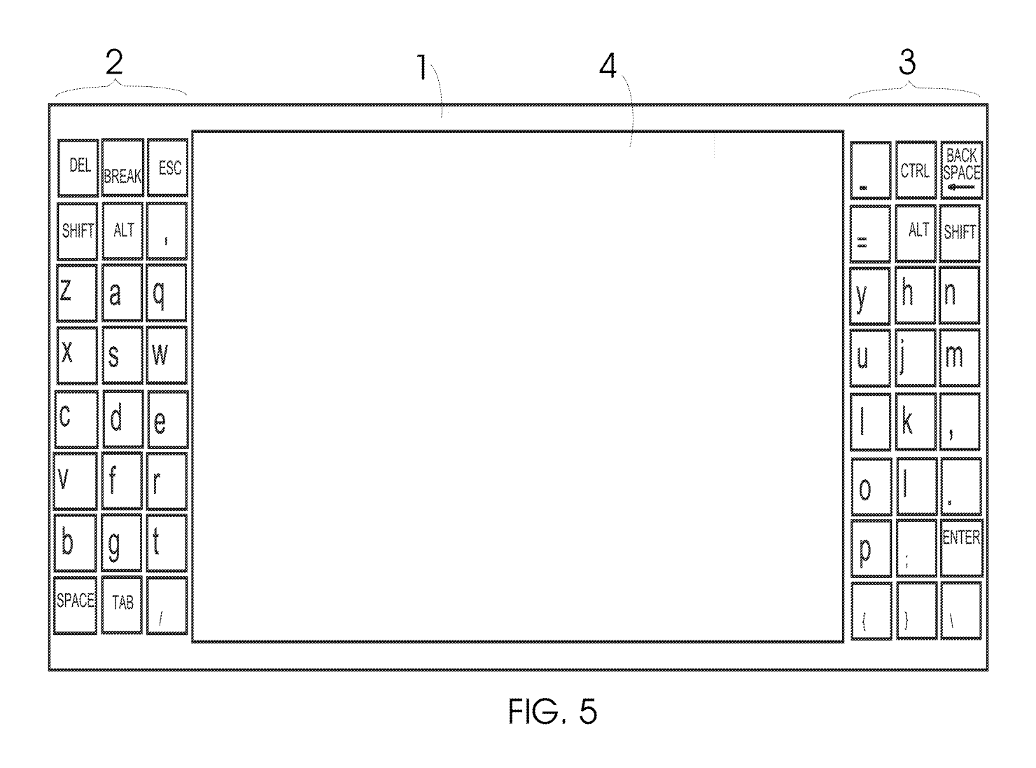

FIG. 5 shows the function of each key of left group of keys (2) and right group of keys (3) while none of the Alt or Shift keys is depressed. It should be understood that various modifications can be made to the invention. Such as:

If the device (1) is a portable keyboard, the display (4) can be omitted. If the display (4) is a touch screen, the right group of keys (3) and left group of keys (2) can be replaced by similar on-screen keyboard. Various popular and foreign keyboard layouts can be used with the right group of keys (3) and left group of keys (2).

I claim:

1. A handheld electronic device arrangement comprising:
a. a display; and
b. a keyboard having:
(i) a left group of keys located on a left side of the display; and
(ii) a right group of keys located on a right side of the display, wherein the left and the right groups of keys are arranged into three rows of keys, all rows of keys are parallel with a longitudinal midline of the device.

2. The keyboard as recited in claim 1, including letter keys arranged longitudinally.

3. The handheld electronic device arrangement as recited in claim 1 including:
a. touchpad located on a back of the device and below the right group of keys; and
b. three mouse buttons located on the back of the device and below the left group of keys.
